(19) United States
(12) Patent Application Publication
(10) Pub. No.: US 2009/0268974 A1
(43) Pub. Date: Oct. 29, 2009

(54) INTRA-PICTURE PREDICTION MODE DECIDING METHOD, IMAGE CODING METHOD, AND IMAGE CODING DEVICE

(76) Inventor: Kazuya Takagi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/095,974

(22) PCT Filed: Dec. 21, 2006
(86) PCT No.: PCT/JP2006/325464

§ 371 Date: Jun. 3, 2008

(30) Foreign Application Priority Data
Dec. 21, 2005 (JP) 2005-367696

(51) Int. Cl. G06K 9/36

(52) U.S. Cl. 382/238

(57) ABSTRACT

Provided is a method and the like for reducing a processing amount required for deciding an intra-picture prediction mode in intra-picture prediction coding, while maintaining the coding efficiency at a certain level. By the method and the like, respective representative values of at least three regions included in a block to be coded are calculated. Then, a difference sum of at least two of the representative values positioned in a direction, and another difference sum of at least two of the representative values positioned in at least one direction different from the above direction are calculated. Next, from among intra-picture prediction modes, at least one intra-picture prediction mode in the direction where the difference sum is a minimum among the calculated difference sums. Thereby, it is possible to reduce the processing amount required for deciding an intra-picture prediction mode.

### TECHNICAL FIELD

The present invention relates to image coding methods and image coding devices, and more particularly to a prediction mode deciding method for intra-picture prediction coding of H.264/AVC.

### BACKGROUND ART

“H.264/AVC” which is a standard for coding moving pictures defined by the International Telecommunication Union Telecommunication Standardization Sector (ITU-T), and the International Organization for Standardization (ISO) and the International Electrotechnical Commission (IEC) achieves a compression efficiency that is twice as high as a compression efficiency of conventional coding standards such as “MPEG-4” and “H.263”. Like the conventional standards, the H.264/AVC standard is characterized in employing intra-picture prediction (hereinafter, referred to also simply as “intra prediction”) coding technologies using spatial correlation, in addition to inter-picture prediction coding technologies using temporal correlation.

The “intra-picture prediction coding” is a technology of executing coding by performing frequency conversion and the like on a residual image between an input image and an intra-picture prediction image generated from the input image. The intra-picture prediction image is an image which is generated by copying pixel values in a direction of an intra-picture prediction mode using pixels neighboring a block to be coded (in more detail, coded pixels immediately above and on the immediately left of the block to be coded). In the H.264/AVC, a various kinds of intra-picture prediction modes (hereinafter, referred to also simply as “prediction modes”) are defined, the number of selectable intra-picture prediction modes is different depending on a size of a block to be coded. More specifically, regarding luminance components in 4×4 pixels or 8×8 pixels, there are nine kinds of prediction modes as shown in FIG. 4 (a), and regarding luminance components of 16×16 pixels, there are four kinds of prediction modes as shown in FIG. 4 (b). Likewise, for chrominance components, there are prepared four kinds of prediction modes as shown in FIG. 4 (b) (hereinafter, unless otherwise stated, the description is given for luminance components of 8×8 pixels.) Here, each of numbers assigned to the respective arrows in FIGS. 4 (a) and (b) is a prediction mode number.

FIG. 5 (a) to (c) are diagrams each showing an example of generation of an intra-picture prediction image by intra-picture prediction using 8×8 pixels. Each of “A” to “Y” in FIG. 5 (a) to (c) represents a value of a pixel neighboring a block to be coded. As shown in FIG. 5(a), in a prediction mode 0 by which intra-picture prediction is to be performed in a vertical direction, values of neighboring pixels are copied in a vertical direction to a generate intra-picture prediction image. Likewise, in a prediction mode 1 by which intra-picture prediction is to be performed in a horizontal direction, as shown in FIG. 5(b), values of neighboring pixels are copied in a horizontal direction to generate an intra-picture prediction image. Furthermore, in a prediction mode 3 by which intra-picture prediction is to be performed in a 45-degree diagonal direction from top left to bottom right, as shown in FIG. 5(c), values of neighboring pixels are copied in a 45-degree diagonal direction from top left to bottom right to generate an intra-picture prediction image.

Next, the description is given for a functional structure of a conventional image coding device 2 which realizes intra-picture prediction coding of the H.264/AVC. FIG. 1 is a functional block diagram showing a structure of the conventional image coding device 2. As shown in FIG. 1, the image coding device 2 includes an intra-picture prediction unit 20, a residual coding unit 11, a residual decoding unit 12, a frame memory 13, a reversible coding unit 14, a differentiator 1000, and an adder 1001. The following describes functions and processing of the respective units one by one.

The intra-picture prediction unit 20 receives a decoded image stored in the frame memory 13, and generates an intra-picture prediction image using pixels neighboring a block to be coded. The intra-picture prediction image is, as described previously, generated by copying values of the neighboring pixels in a prediction direction defined by the best (optimum) prediction mode selected from the various kinds of prediction modes. The intra-picture prediction image generated by the intra-picture prediction unit 20 is provided to the differentiator 1000 and the adder 1001.

The residual coding unit 11 receives a residual image between an input image and the intra-picture prediction image from the differentiator 1000, and performs (i) frequency conversion such as discrete cosine transformation or Karhunen-Loeve transformation and (ii) quantization on the residual image, thereby generating a residual signal. The resulting residual signal is provided to the reversible coding unit 14 and the residual decoding unit 12.

The residual decoding unit 12 receives the residual signal from the residual coding unit 11, and performs inverse quantization and inverse frequency conversion on the received residual signal, thereby generating a residual decoded image. The resulting residual decoded image is provided to the adder 1001.

The adder 1001 receives the intra-picture prediction image from the intra-picture prediction unit 20, and the residual decoded image from the residual coding unit 11, and then adds the intra-picture prediction image and the residual decoded image together, thereby generating a decoded image to be provided to the frame memory 13.

The frame memory receives the decoded image from the adder 1001, and stores the decoded image. The stored decoded image is provided to the intra-picture prediction unit 20, when an intra-picture prediction image is to be generated.

The reversible coding unit 14 receives the residual signal from the residual coding unit 11, and performs reversible coding using variable length coding or arithmetic coding on the received residual signal, thereby generating a coded word. The resulting coded word is a final coded image.

FIG. 8 is a flowchart of processing performed by the conventional image coding device 2 of FIG. 1. The following processing is performed for each block which is a size applied with the frequency conversion (hereinafter, referred to also as a “frequency conversion size”).

Firstly, assuming that a residual between an input image “org_blk” and an intra-picture prediction image “prd_blk[mode]” (where mode=0, 1, . . . , 8) is a prediction evaluation value “cost”, the intra-picture prediction unit 20 selects the best intra-picture prediction mode “best_mode” having a minimum prediction value “min_cost” from the various kinds of intra-picture prediction modes (Step A0). This is because it is considered that, the smaller the residual between (i) an input image and (ii) an intra-picture prediction image generated from the same picture in which the input image is included is, the more the coding efficiency is improved. A flow of the processing of the above steps is explained in more detail further below.

Next, by copying values of neighboring pixels in a prediction direction defined by the best prediction mode “best_modet” selected at Step A0, the intra-picture prediction unit 20 generates an intra-picture prediction image “prd_blk [best_mode]” (Step A1).

Then, the differentiator 101 generates a residual image “diff_blk” which is a residual between the input image “org_blk” and the intra-picture prediction image “prd_blk [best_mode]” generated at the above-described Step A1 (Step A2).

Further, on the residual image “diff_blk” generated at the above-described Step A2, the residual coding unit 11 performs (i) frequency conversion such as discrete cosine transformation or Karhunen-Loeve transformation and (ii) quantization, thereby generating a residual signal “diff_signal” (Step A3).

Finally, on the residual signal “diff_signal” generated at Step A3, the reversible coding unit 14 performs reversible coding using variable length coding or arithmetic coding, thereby generating a coded word (Step A4).

The above has described the flow of the conventional intra-picture prediction coding of the H.264/AVC.

Next, the processing of deciding the best intra-picture prediction mode “best_modet” at Step A0 of FIG. 8 is described in more detail. FIG. 9 is a flowchart of processing of selecting candidates of the best intra-picture prediction mode (hereinafter, referred to also as “intra-picture prediction mode candidates). Like the processing of FIG. 8, the following processing is performed for each block which is a size applied with the frequency conversion.

Firstly, the intra-picture prediction mode candidate selection unit 101 selects a candidate of each intra-picture prediction mode “mode” (where mode=0, 1, . . . , 8) (Step B0). In this case, each candidate is designated using a candidate flag “flag[mode]”. If the candidate flag “flag[mode]” has a value of “1”, the candidate flag “flag[mode]” indicates that the target intra-picture prediction mode is the candidate. On the other hand, the candidate flag “flag[mode]” has a value of “0”, the candidate flag “flag[mode]” indicates that the intra-picture prediction mode is not the candidate. A flow of the processing of the above steps is explained in more detail further below.

Next, the intra-picture prediction mode decision unit 102 initializes (i) a prediction evaluation value “min_cost” of the best intra-picture prediction mode and (ii) the best intra-picture prediction mode “best_mode” (Step B1). The prediction evaluation value “min_cost” of the best intra-picture prediction mode is set to a value “MAXCOST” which is too large for a prediction evaluation value. The best intra-picture prediction mode “best_mode” is set to an intra-picture prediction mode “BESTMODE” which is an arbitrary intra-picture prediction mode where mode is 0, 1, . . . , 8.

Then, for each intra-picture prediction mode “mode” (where mode=0, 1, . . . , 8) (Step B2), the intra-picture prediction mode decision unit 102 determines whether the candidate flag “flag[mode]” is 0 or 1 (Step B3). If a candidate “flag[mode]” of a target intra-picture prediction mode “mode” is “1” (in other words, if a target intra-picture prediction mode “mode” is an intra-picture prediction candidate), then values of neighboring pixels are copied in an intra-picture prediction direction defined by the target intra-picture prediction mode “mode”, thereby generating an intra-picture prediction image “prd_blk[mode]” (Step B4). Furthermore, the intra-picture prediction mode decision unit 102 calculates a prediction evaluation value “cost” using an input image “org_blk” and the intra-picture prediction image “prd_blk[mode]” generated at Step C4 (Step B5).

Finally, the intra-picture prediction mode decision unit 102 compares the prediction evaluation value “cost” calculated at Step B5 to the prediction evaluation value “min_cost” of the best intra-picture prediction mode, to determine which is smaller. (Step B6). If the prediction evaluation value “cost” is smaller than the prediction evaluation value “min_cost”, then the prediction mode decision unit 302 replaces the prediction evaluation value “min_cost” of the best intra-picture prediction mode by the prediction evaluation value “cost”, and replaces (updates) the best intra-picture prediction mode “best_mode” by the intra-picture prediction mode “mode” (Step B7).

The above-described processing is performed for each intra-picture prediction mode “mode” (where mode=0, 1, . . . , 8), so that the best intra-picture prediction mode “best_mode” having a minimum prediction evaluation value can be decided from among the intra-picture prediction mode candidates.

However, in the above-described conventional intra-picture prediction coding method, when the best intra-picture prediction mode is to be decided, for every intra-picture prediction mode it is necessary to generate an intra-picture prediction image and calculate a prediction evaluation value between an input image and the generated intra-picture prediction image. Therefore, as disclosed in Non-Patent Reference 1, there have been proposed a method of selecting intra-picture prediction mode candidates based on edge characteristics of an input image (refer to Non-Patent Reference 1, for example), and a method of selecting intra-picture prediction mode candidates based on frequency characteristics of an input image (refer to Non-Patent Reference 2, for example).

Firstly, the method of deciding a prediction mode based on edge characteristics is explained. The method based on edge characteristics is in accordance with the observation that a prediction direction of the best intra-picture prediction mode nearly matches an edge direction.

FIG. 2 is a block diagram showing the intra-picture prediction unit 20 which realizes the selecting of intra-picture prediction mode candidates based on edge characteristics. As shown in FIG. 2, the intra-picture prediction unit 20 includes an edge characteristic analysis unit 100, a prediction mode candidate selection unit 101, and a prediction mode decision unit 102. The following describes functions and processing of the respective units one by one.

The edge characteristic analysis unit 100 receives an input image, filters each pixel in the input image using a SOBEL filter which is an edge detection filter, and classifies edge directions into intra-picture prediction directions as shown in FIG. 6, thereby generating a histogram. Then, as edge characteristic information, the edge characteristic analysis unit 100 provides the histogram to the prediction mode candidate selection unit 101.

From the edge characteristic information provided from the edge characteristic analysis unit 100, the prediction mode candidate selection unit 101 selects, as candidates, (i) an intra-picture prediction mode having the most frequent (most used) intra-picture prediction direction and (ii) intra-picture prediction modes each having a direction near the most frequent intra-picture prediction direction. Then, as the prediction mode candidate information, the prediction mode candidate selection unit 101 provides the intra-picture prediction mode candidates to the prediction mode decision unit 102.

The prediction mode decision unit 102 receives the prediction mode candidate information from the prediction mode candidate selection unit 101, then selects one intra-picture prediction mode from the intra-picture prediction mode candidates, and eventually outputs an intra-picture prediction image corresponding to the selected intra-picture prediction mode.

The above has described the intra-picture prediction unit 20 which realizes the selecting of intra-picture prediction mode candidates based on edge characteristics.

Next, a flow of the selecting of prediction mode candidates based on edge characteristics is explained. FIG. 10 is a flowchart of the selecting of intra-picture prediction mode candidates based on edge characteristics. The following processing is performed for each block which is a size applied with the frequency conversion.

Firstly, the intra-picture prediction mode candidate selection unit 101 initializes a candidate flag “flag[mode]” of each intra-picture prediction mode “mode” (where mode=0, 1, . . . , 8) to “0” (Step C0).

Next, for each pixel in a block which is an input image “org_blk” (Step C1), the edge characteristic analysis unit 100 filters each pixel using the SOBEL filter (Step C2), and classifies edge directions of each pixel into intra-picture prediction directions and counts a used rate (using frequency) of each of the intra-picture prediction directions (Step C3).

Then, finally, each of candidate flags “flag[mode_edge]” of (i) an intra-picture prediction mode “mode_edge” having the most frequent intra-picture prediction direction and (ii) intra-picture prediction modes “mode_edge” each having a direction near the most frequent intra-picture prediction direction is set to “1” (Step C4).

The above has described the flowchart of the selecting of intra-picture prediction mode candidate based on edge characteristics.

Firstly, the method of deciding the prediction mode candidates based on frequency characteristics is explained.

FIG. 3 is a block diagram showing an intra-picture prediction unit 21 which realizes the selecting of intra-picture prediction mode candidates based on frequency characteristics. As shown in FIG. 3, the intra-picture prediction unit 21 includes a frequency characteristic analysis unit 200, a prediction mode candidate selection unit 201, and a prediction mode decision unit 202. The following describes functions and processing of the respective units one by one.

The frequency characteristic analysis unit 200 receives an input image, performs frequency conversion such as discrete cosine transformation or Karhunen-Loeve transformation on the received input image, and calculates four variables of a frequency component in a horizontal direction, a frequency component in a vertical direction, an energy intensity in a horizontal direction, and an energy intensity in a vertical direction. Then, as frequency characteristic information, the frequency characteristic analysis unit 200 provides the four variables to the prediction mode candidate selection unit 201.

The prediction mode candidate selection unit 201 receives the frequency characteristic information from the frequency characteristic analysis unit 200, classifies intra-picture prediction modes into a distribution pattern shown in FIG. 7 based on biases of the frequency components and energy intensity in horizontal and vertical directions, and selects intra-picture prediction mode candidates from the distribution pattern. Then, as the prediction mode candidate information, the prediction mode candidate selection unit 201 provides the intra-picture prediction mode candidates to the prediction mode decision unit 202.

In the same manner as the prediction mode decision unit 102, the prediction mode decision unit 202 receives the prediction mode candidate information from the prediction mode candidate selection unit 201, then selects one intra-picture prediction mode from the intra-picture prediction mode candidates, and eventually outputs an intra-picture prediction image corresponding to the selected intra-pixel prediction mode.

The above has described the intra-picture prediction unit 21 which realizes the selecting of intra-picture prediction mode candidates based on frequency characteristics.

Next, processing of the selecting of intra-picture prediction candidates based on frequency characteristics is described. FIG. 11 is a flowchart of the selecting of intra-picture prediction mode candidates based on frequency characteristics. The following processing is performed for each block which is a size applied with the frequency conversion.

Firstly, the prediction mode candidate selection unit 2301 initializes a candidate flag “flag[mode]” of each intra-picture prediction mode “mode” (where mode=0, 1, . . . , 8) to “0” (Step D0).

Next, the frequency characteristic analysis unit 200 performs frequency conversion such as discrete cosine transformation or Karhunen-Loeve transformation on an input image “org_blk” (Step D1), and calculates horizontal and vertical frequency components CH and CV (Step D2) and horizontal and vertical energy intensity EH and EV (Step D3).

Then, finally, the prediction mode candidate selection unit 201 classifies intra-picture prediction modes into a distribution pattern shown in FIG. 7 based on the horizontal and vertical frequency components CH and CV and horizontal and vertical energy intensity EH and EV (Step D4), and sets a candidate flag “flag[mode_freq]” of each of corresponding intra-picture prediction modes “mode_freq” to 1 (Step D5).

The above has described the flowchart of the selecting of intra-picture prediction mode candidates based on frequency characteristics.

### [Non-Patent Reference 1] “Fast Mode Decision for Intra Prediction”, Feng P. et al, JVT-GO13, March, 2003.

[Non-Patent Reference 2] “Shuhasu Tokusei ni Motozuku H.264/AVC Intora Yosoku Modo Kettei Houhou ni Kansuru Kento (H.264/AVC Intra-Prediction Mode Decision based on Frequency Characteristic)”, Tsukuba, Nagayoshi, Hanamura, and Tominaga, 2004-AVM-47

### DISCLOSURE OF INVENTION

### Problems that Invention is to Solve

However, the above-described two conventional methods have a problem of a large processing amount, because the application of an edge detection filter or the frequency conversion such as discrete cosine transformation or Karhunen-Loeve transformation is to be performed on an input image.

In view of the above problem, an object of the present invention is to provide an image coding method, an image coding device, and the like for considerably reducing a processing amount while maintaining the coding efficiency at a certain level.

### Means to Solve the Problems

In accordance with an aspect of the present invention for achieving the above object, there is provided a method of deciding an intra-picture prediction mode, the method being used by an image coding device which codes a residual between an input image and a generated intra-picture prediction image, and the method including: calculating (i) a characteristic amount of each of at least three sub-blocks included in a block to be coded, the block being a part of the input image, and (ii-1) a difference in the characteristic amount between at least two of the sub-blocks along a prediction direction and (ii-2) a difference in the characteristic amount between at least two of the sub-blocks along another prediction direction different from the prediction direction; selecting at least one intra-picture prediction mode candidate corresponding to one of the prediction direction and the another prediction direction where the difference in the characteristic amount is smaller of the calculated differences; and deciding an intra-picture prediction mode from among the at least one intra-picture prediction mode candidate selected in the selecting.

Thereby, in the intra-picture prediction mode decision method according to the present invention, it is possible to reduce the number of processes for generating plural intra-picture prediction images for deciding a prediction mode, which results in reduction of a processing amount required for the generating processes.

It is possible that the prediction direction is orthogonal to the another prediction direction, and that in the calculating of the differences, (ii-1) a difference in the characteristic amount between the two sub-blocks along the prediction direction and (ii-2) a difference in the characteristic amount between at least two of the sub-blocks along the another prediction direction are calculated.

Thereby, since the two directions are at a 90 degree angle to each other, the intra-picture prediction mode decision method according to the present invention achieves excellent a separation capability related to the selecting of intra-picture prediction direction candidates.

It is also possible that the block to be coded is divided into four rectangular sub-blocks which are positioned at an upper left corner of, at an upper right corner of, at an bottom left corner of, and at an bottom right corner of the block to be coded, respectively, and that in the calculating of the differences, (ii-1) a difference in the characteristic amount between the sub-block at the upper left corner and the sub-block at the bottom right corner and (ii-2) a difference in the characteristic amount between the sub-block at the upper right corner and the sub-block at the bottom left corner are calculated.

Thereby, in the intra-picture prediction mode decision method according to the present invention, from among all of intra-picture prediction modes, it is possible to calculate (i) a difference sum regarding an intra-picture prediction mode in which intra-picture prediction is to be performed in a vertical direction, (ii) a difference sum regarding another intra-picture prediction mode in which intra-picture prediction is to be performed in a horizontal direction, (iii) a difference sum regarding still another intra-picture prediction mode in which intra-picture prediction is to be performed in a 45-degree diagonal direction, that is a middle direction between the vertical direction and the horizontal direction. Here, the three types of intra-picture prediction modes are frequently used in intra picture prediction. As a result, the intra-picture prediction mode decision method according to the present invention achieves excellent a separation capability related to the selecting of intra-picture prediction direction candidates.

It is also possible that in the calculating of the characteristic amount, the characteristic amount is calculated using only pixels in a top row and pixels in a far-left column regarding each of the sub-blocks.

Thereby, by using pixels near neighboring pixels which are actually used for generating the intra-picture prediction image, the intra-picture prediction mode decision method according to the present invention can improve an accuracy of the selecting of the prediction mode candidates.

It is also possible that in the calculating of the difference in the characteristic amount, a difference between (1) the characteristic amounts near a starting point of the prediction direction.

Thereby, by using pixels near neighboring pixels which are actually used for generating the intra-picture prediction image, the intra-picture prediction mode decision method according to the present invention can improve an accuracy of the selecting of the prediction mode candidates.

Furthermore, in accordance with another aspect of the present invention for achieving the above object, there is provided an image coding device which codes a residual between an input image and a generated intra-picture prediction image, the device including: a characteristic amount distribution unit operable to calculate (i) a characteristic amount of each of at least three sub-blocks included in a block to be coded, the block being a part of the input image, and (ii-1) a difference in the characteristic amount between at least two of the sub-blocks along a prediction direction and (ii-2) a difference in the characteristic amount between at least two of the sub-blocks along another prediction direction different from the prediction direction; a prediction mode candidate selection unit operable to select at least one intra-picture prediction mode candidate corresponding to one of the prediction direction and the another prediction direction where the difference in the characteristic amount is smaller of the calculated differences; a prediction mode decision unit operable to decide an intra-picture prediction mode from among the at least one intra-picture prediction mode candidate selected by the prediction mode candidate selection unit; and a residual coding unit operable to code the residual between the input image and an intra-picture prediction image which is generated using the intra-picture prediction mode decided by the prediction mode decision unit.

It should be noted that the present invention can be realized also as: an image coding method including steps performed by the units of the above-mentioned intra-picture prediction mode deciding method; a program causing a computer to execute the steps; and the like. It should also be noted that the program may be, of course, widely distributed via a recording medium such as a DVD or a transmission medium such as the Internet.

It should further be noted that the present invention can be realized also as an integrated circuit having the units of the above-mentioned image coding device.

### EFFECTS OF THE INVENTION

The present invention can decide an intra-picture prediction mode with a small processing amount, thereby reducing an IC cost required for achieving high-speed image processing and the above method and the like, and also reducing power consumption.

### BRIEF DESCRIPTION OF DRAWINGS

FIG. 1 is a functional block diagram showing a structure of an image coding device according to the conventional image coding device and also according to the first embodiment of the present invention.

FIG. 2 is a functional block diagram showing a structure of a conventional intra-picture prediction unit using edge characteristics.

FIG. 3 is a functional block diagram showing a structure of a conventional intra-picture prediction unit using frequency characteristics.

FIGS. 4 (a) and (b) are diagrams each showing intra-picture prediction modes and their directions in the H.264/AVC.

FIG. 5 (a) to (c) are diagrams each showing an example of generation of an intra-picture prediction image by intra-picture prediction using 8×8 pixels.

FIG. 6 is one example of a histogram in the case where edge directions are classified into directions of intra-picture prediction modes.

FIG. 7 is a table showing one example of relationships between frequency characteristics and intra-picture prediction mode candidates.

FIG. 8 is a flowchart of intra-picture prediction coding.

FIG. 9 is a flowchart of intra-picture prediction.

FIG. 10 is a flowchart of conventional processing of selecting of intra-picture prediction mode candidates based on edge characteristics.

FIG. 11 is a flowchart of conventional processing of selecting of intra-picture prediction mode candidates based on frequency characteristics.

FIG. 12 is a functional block diagram showing an intra-picture prediction unit according to the first embodiment of the present invention.

FIG. 13 is a diagram showing one example of relationships between sub-blocks and directions used for selecting of intra-picture prediction mode candidates, according to the first embodiment of the present invention.

FIGS. 14 (a) and (b) are diagrams each showing another example of relationships between sub-blocks and directions used for selecting of intra-picture prediction mode candidates, according to the first embodiment of the present invention.

FIGS. 15 (a) and (b) are diagrams each showing a modification of the relationships between sub-blocks and directions used for selecting of intra-picture prediction mode candidates, according to the first embodiment of the present invention.

FIGS. 16 (a) and (b) are diagrams each showing one example of using a part of pixels in a sub-block when a characteristic amount is to be calculated.

FIG. 17 is a flowchart of processing of selecting of intra-picture prediction mode candidates based on characteristic amount distribution characteristics according to the first embodiment of the present invention.

### NUMERICAL REFERENCES

1, 2 image coding device
10, 20, 21 intra-picture prediction unit
11 residual coding unit
12 residual decoding unit
13 frame memory
14 reversible coding unit
100 edge characteristic analysis unit
101 prediction mode candidate selection unit
102 prediction mode decision unit
200 frequency characteristic analysis unit
201 prediction mode candidate selection unit
202 prediction mode decision unit
300 characteristic amount distribution analysis unit
301 prediction mode candidate selection unit
302 prediction mode decision unit
1000 subtractor
1001 adder
A to Y neighboring pixel

### BEST MODE FOR CARRYING OUT THE INVENTION

The following describes preferred embodiments of an image coding device according to the present invention with reference to the drawings. It should be noted that the present invention will be described by the following embodiments and with reference to the attached drawings, but these embodiments and drawings are provided as merely examples and do not limit the scope of the present invention.

### First Embodiment

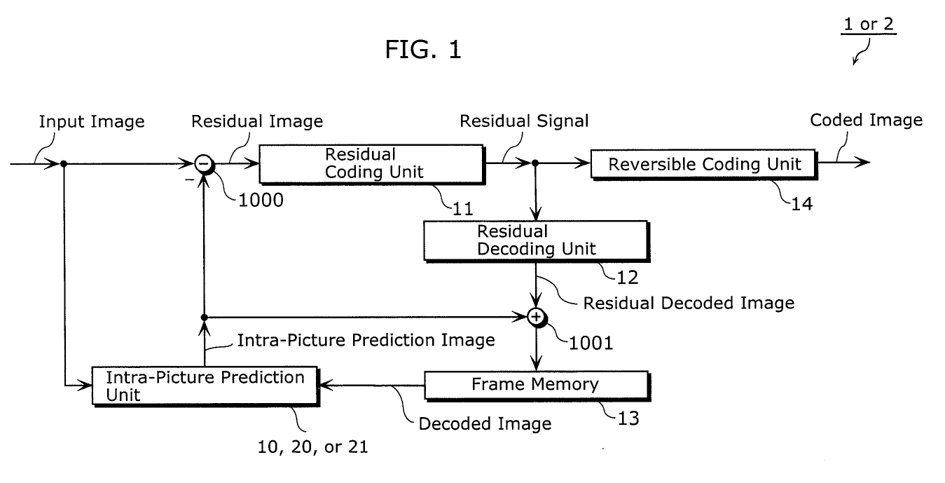

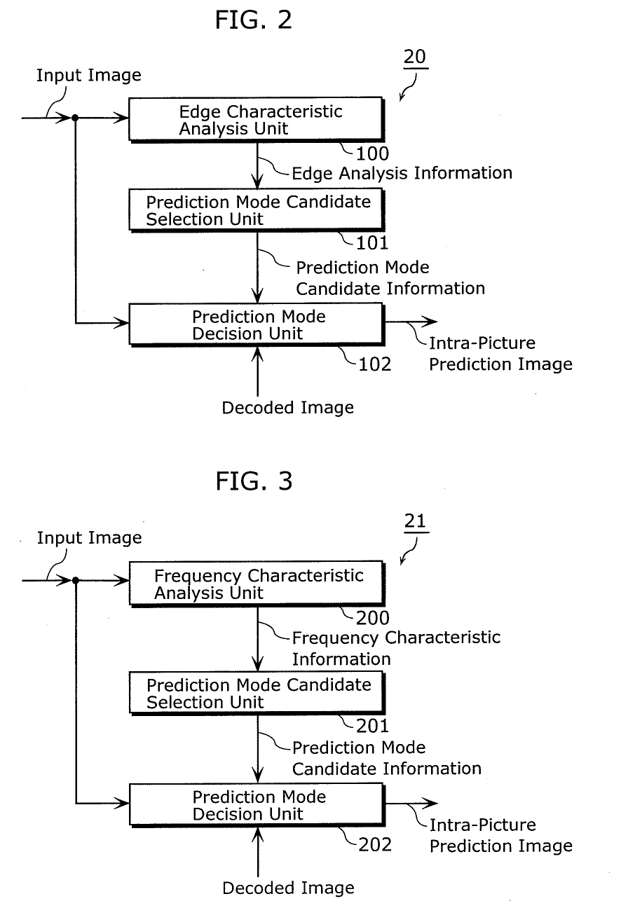

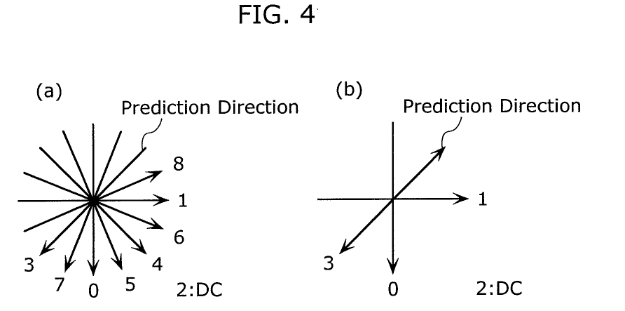

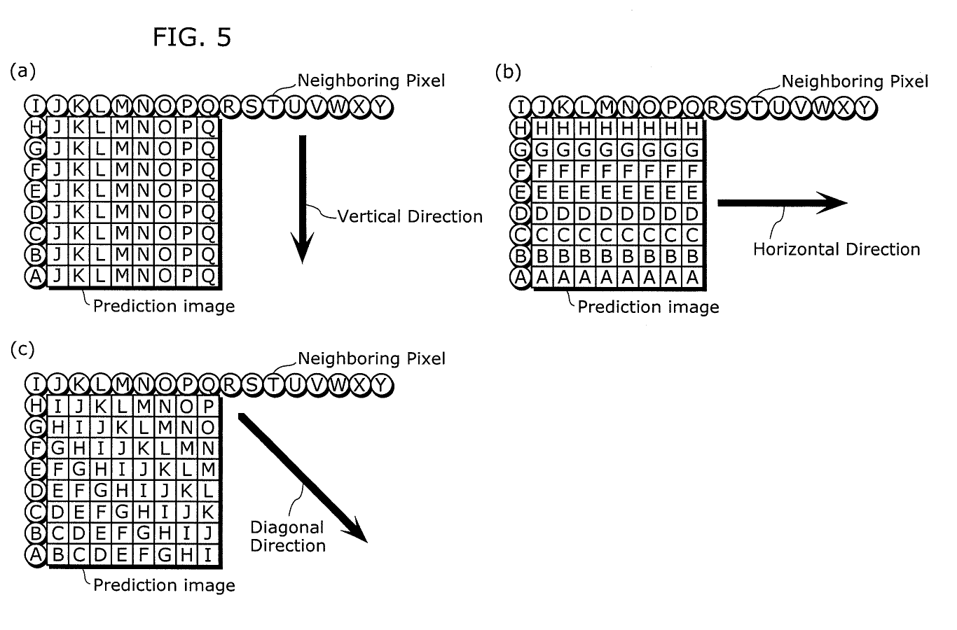

FIG. 1 also shows a functional block diagram of an image coding device 1 according to the first embodiment of the present invention. As shown in FIG. 1, the image coding device 1 has the same functional structure as the conventional image coding device 2 except an intra-picture prediction unit 10.

The intra-picture prediction unit 10 receives a decoded image stored in the frame memory 13, and generates an intra-picture prediction image using pixels neighboring a block to be coded. In addition, the intra-picture prediction unit 10 selects prediction mode candidates to be evaluated based on a characteristic amount of image of each of sub-blocks included in the block to be coded, then decides one prediction mode from the selected candidates, and eventually generates an intra-picture prediction image according to the decided prediction mode. The intra-picture prediction image generated by the intra-picture prediction unit 10 is provided to the differentiator 1000 and the adder 1001.

The following mainly describes the intra-picture prediction unit 10 which is a characteristic feature of the present invention.

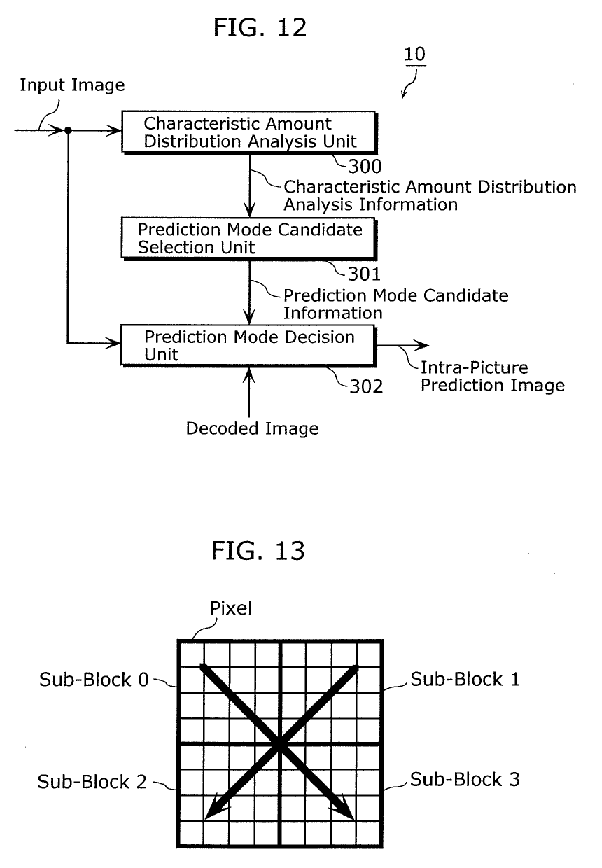

FIG. 12 is a functional block diagram of the intra-picture prediction unit 10 in the image coding device 1 of FIG. 1. As shown in FIG. 12, the intra-picture prediction unit 10 includes a characteristic amount distribution analysis unit 300, a prediction mode candidate selection unit 301, and a prediction mode decision unit 302. Hereinafter, functions of these units are explained with reference to FIGS. 13 to 17.

The characteristic amount distribution analysis unit 300 receives an input image, and then, as shown in FIG. 13, calculates a characteristic amount of image (hereinafter, in the first embodiment, referred to as a “luminance average value “avg[i]””) for each of four sub-blocks “i” (where i=0, 1, 2, 3) included in a block to be coded which corresponds to the input image. The luminance average value “avg[i]” is determined using the following equation (1).

$$\begin{matrix}[ Equation 1 ] & \\ avg [ i ] = {\sum }_{j ∈ SubBlock\_i} {org\_blk}_{j} / n & ( 1 )\end{matrix}$$

Here, j represents pixel coordinates, and n represents the number of pixels in a sub-block “i”. In the example of FIG. 13, since a frequency conversion size is 8×8 pixels, a size of each sub-block “i” (where i=0, 1, 2, 3) is 4×4 pixels (in other words, the number of pixels “n” is “16”). Then, the characteristic amount distribution analysis unit 300 calculates (i) an absolute differential value “delta_a” of luminance average values between two of the sub-blocks “i” (where i=0, 3) which are positioned along a direction from top left to bottom right in the block to be coded and (ii) an absolute differential value “delta_b” of luminance average values between two of the sub-blocks “i” (where i=1, 2) which are positioned along a direction from top right to bottom left in the block to be coded. That is, the absolute differential values “delta_a” and “delta_b” are determined using the following equations (2) and (3), respectively.

[Equation 2]

delta_{—}a=|avg[0]−avg[3]| (2)

[Equation 3]

delta_{—}b=|avg[1]−avg[2]| (3)

Then, as characteristic amount distribution information, the characteristic amount distribution analysis unit 300 provides the absolute differential values “delta_a” and “delta_b” to the prediction mode candidate selection unit 301.

The prediction mode candidate selection unit 301 receives the characteristic amount distribution information from the characteristic amount distribution analysis unit 300, and selects intra-picture prediction mode candidates by comparing the absolute differential values “delta_a” and “delta_b” to each other in order to determine which is smaller. In more detail, if the absolute differential value “delta_a” is smaller than the absolute differential value “delta_b”, then intra-picture prediction modes “mode” (where mode=4, 5, 6) by which intra-picture prediction is performed in a direction from top left to bottom right are selected as intra-picture prediction mode candidates. On the other hand, if the absolute differential value “delta_b” is smaller than the absolute differential value “delta_a”, then intra-picture prediction modes “mode” (where mode=3, 7, 8) by which intra-picture prediction is performed in a direction from top right to bottom left are selected as intra-picture prediction mode candidates Then, as prediction mode candidate information, the prediction mode candidate selection unit 301 provides the intra-picture prediction modes selected as the candidates to the prediction mode decision unit 302.

In the same manner as the conventional prediction mode decision unit 102 and prediction mode decision unit 202, the prediction mode decision unit 302 receives the prediction mode candidate information from the prediction mode candidate selection unit 301, selects one intra-picture prediction mode from the intra-picture prediction mode candidates, and eventually generates an intra-picture prediction image according to the selected intra-picture prediction mode and outputs the generated intra-picture prediction image.

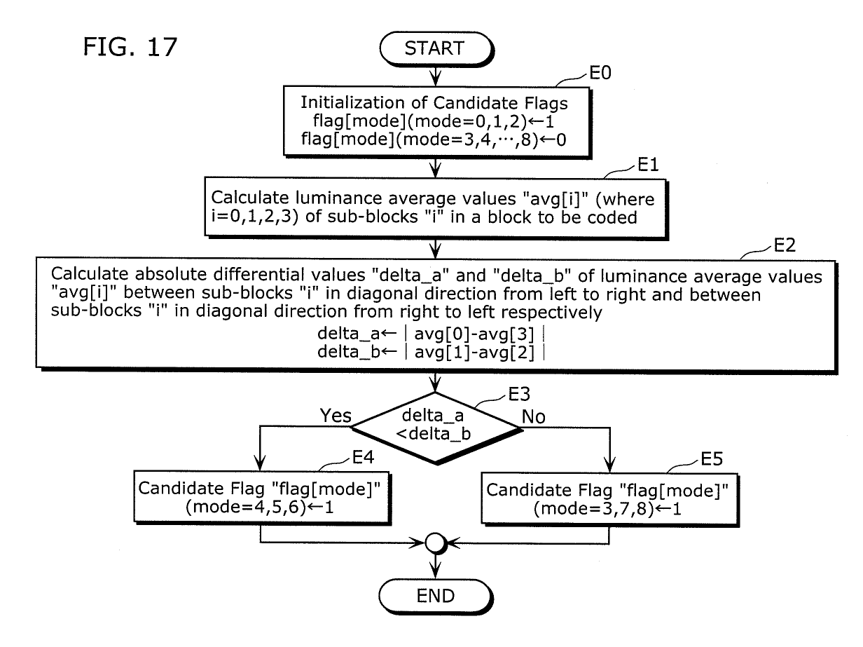

Next, the processing of selecting of intra-picture prediction mode candidates by the intra-picture prediction unit 10 according to the first embodiment is described. FIG. 17 is a flowchart of the processing of selecting of intra-picture prediction mode candidates by the intra-picture prediction unit 10. The following processing is performed for each block which is a size applied with the frequency conversion.

Firstly, as fixed intra-picture prediction mode candidates, the prediction mode candidate selection unit 301 selects a vertical prediction mode by which intra-picture prediction is to be performed in a vertical direction, a horizontal prediction mode by which intra-picture prediction is to be performed in a vertical direction, and a DC prediction mode by which intra-picture prediction is to be performed in a diagonal direction, which are frequently used in intra-picture prediction (Step E0). This is because image generally includes many textures in a vertical direction and in a horizontal direction. As described previously, each of the prediction mode candidates is designated using a candidate flag “flag[mode]” (where mode=0, 1, . . . , 8). At Step E0, each of candidate flags “flag[mode]” (where mode=0, 1, 2) is set to “1”, and each of candidate flags “flag[mode]” (where mode=3, 4, . . . , 8) is set to “0”.

Next, as shown in FIG. 13, the characteristic amount distribution analysis unit 300 calculates a luminance average value “avg[i]” of each of the four sub-blocks “i” (where i=0, 1, 2, 3) included in the block to be coded (Step E1). As previously described, the luminance average value “avg[i]” is determined using the equation (1).

Then, the characteristic amount distribution analysis unit 300 calculates absolute differential values “delta_a” and “delta_b” of luminance average values “avg[i]”, between the sub-blocks “i” positioned along a direction from top left to bottom right and between the sub-blocks “i” positioned along a direction from top right to bottom left, respectively (Step E2).

The absolute differential value “delta_a” regarding the direction from top left to bottom right is determined using the above equation (2), using luminance average values “avg[i]” of sub-blocks “i” (where i=0, 3) which are positioned at the upper left corner and at the bottom right corner of the block to be coded, respectively, in FIG. 13. Likewise, the absolute differential value “delta_b” regarding the direction from top right to bottom left is determined using the above equation (3), using luminance average values “avg[i]” of sub-blocks “i” (where i=1, 2) which are positioned at the upper right corner of and at the bottom left corner of the block to be coded, respectively (Step E2).

In addition, the prediction mode candidate selection unit 301 compares the absolute differential values “delta_a” and “delta_b” to each other in order to determine which is smaller (Step E3). If the absolute differential value “delta_a” is smaller than the absolute differential value “delta_b”, then intra-picture prediction modes “mode” (where mode=4, 5, 6) by which intra-picture prediction is performed in a direction from top left to bottom right are selected as prediction mode candidates. More specifically, each of the candidates flags “flag[mode]” (where mode=4, 5, 6) is set to “1” (Step E4).

On the other hand, if the absolute differential value “delta_b” is smaller than the absolute differential value “delta_a”, then intra-picture prediction modes “mode” (where mode=3, 7, 8) by which intra-picture prediction is performed in a direction from top right to bottom left are selected as prediction mode candidates. More specifically, each of the candidates flags “flag[mode]” (where mode=3, 7, 8) is set to “1” (Step E5).

As described above, the image coding device 1 according to the first embodiment can select intra-picture prediction mode candidates by which intra-picture prediction is performed in a diagonal direction with a small processing amount, which makes it possible to reduce an entire processing amount required for the intra-picture prediction.

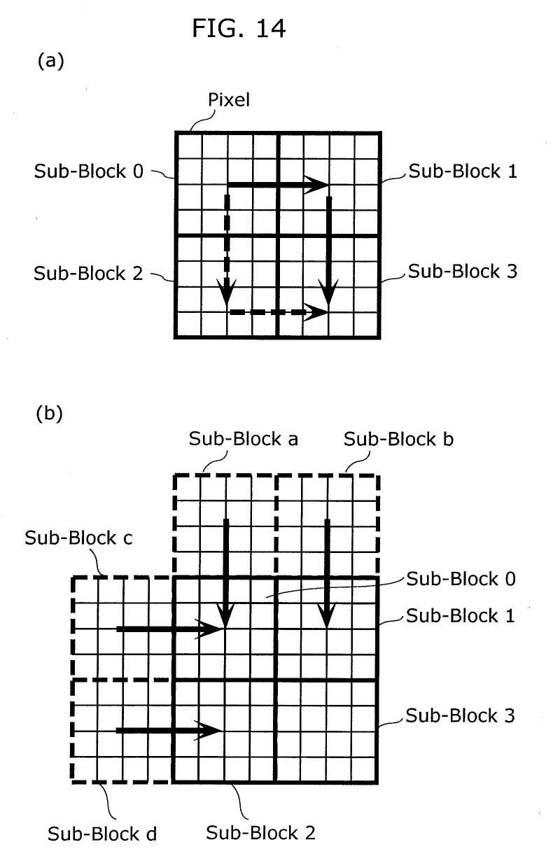

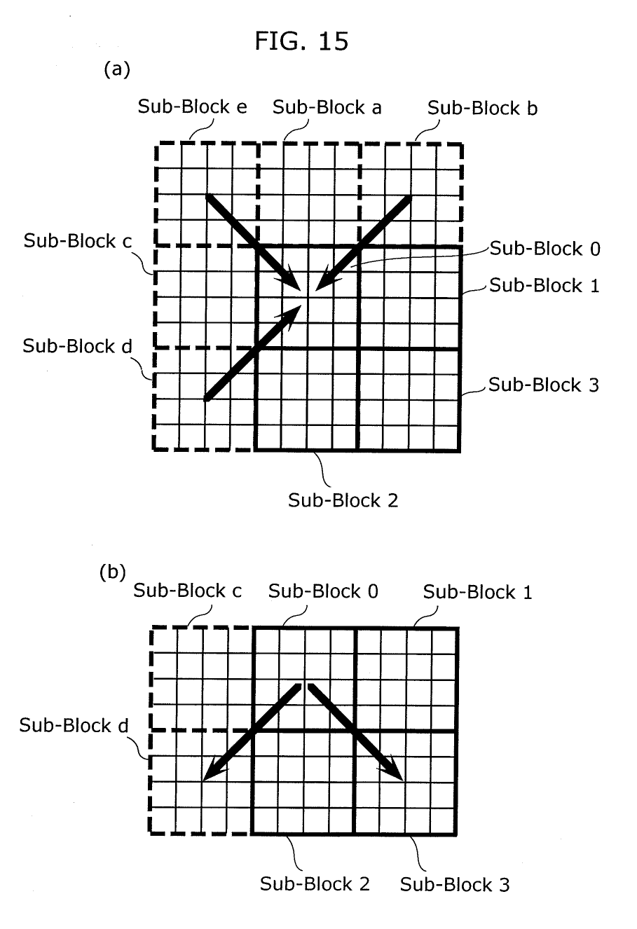

It should be noted that, in the characteristic amount distribution analysis unit 300, the relationship among the sub-blocks which are used to calculate the absolute differential is values “delta_a” and “delta_b” of the luminance average values is not limited to FIG. 13. For example, sub-blocks may have a relationship as shown in FIG. 14 or 15.

FIGS. 14 (a) and (b) are diagrams each showing another example of a relationship between (i) sub-blocks and (ii) directions used for selecting intra-picture prediction mode candidates, according to the first embodiment of the present invention. As shown in FIG. 14 (a), it is possible that the absolute differential value “delta_a” (shown by a solid line) is calculated using a sub-block 0 and a sub-block 1, and the absolute differential value “delta_b” (shown by another solid line) is calculated using the sub-block 1 and a sub-block 3 (of course, it is also possible that the absolute differential value “delta_a” (shown by a dashed line) is calculated using the sub-block 0 and a sub-block 2, and the absolute differential value “delta_b” (shown by another dashed line) is calculated using the sub-block 2 and the sub-block 3).

Moreover, as shown in FIG. 14 (b), it is possible that the absolute differential value “delta_a” is calculated using a coded sub-block a and the sub-block 0, and the absolute differential value “delta_b” is calculated using a coded sub-block c and the sub-block 0 (of course, it is also possible that the absolute differential value “delta_a” is calculated using a coded sub-block d and the sub-block 2, and the absolute differential value “delta_b” is calculated using a coded sub-block b and the sub-block 1).

FIGS. 15 (a) and (b) are diagrams each showing a modification of a relationship between (i) sub-blocks and (ii) directions used for selecting intra-picture prediction mode candidates according to the first embodiment of the present invention. As shown in FIG. 15 (a), it is possible that the absolute differential value “delta_a” is calculated using a coded sub-block e and the sub-block 0, and the absolute differential value “delta_b” is calculated using a coded sub-block b and the sub-block 0 (of course, it is also possible that the absolute differential value “delta_b” is calculated using a coded sub-block d and the sub-block 0, instead of using the coded sub-block b and the sub-block 0).

Furthermore, as shown in FIG. 15 (b), it is also possible that the absolute differential value “delta_a” is calculated using the sub-block 0 and the coded sub-block d, and the absolute differential value “delta_b” is calculated using the sub-block 0 and the sub-block 3.

### Second Embodiment

It has been described in the first embodiment that a prediction mode is decided for the intra-picture prediction coding method, by selecting prediction mode candidates based on a characteristic amount of image of each of sub-blocks included in a block to be coded. However, in the second embodiment, there is provided an image coding device which also uses intermediate data of quantization modulation by which a plane part of image is quantized finely and a complicated part of the image is quantized roughly. The quantization modulation, which is one of subjective quality improvement methods, improves image quality of a plane part relatively, based on the observation that human eyes are sensitive to see a plane part but insensitive to see a complicated part.

In the quantization modulation used in the second embodiment, an input image is classified into a plane part and a complicated part according to a luminance distribution value “var” of the input image. Here, a luminance average value “avg” necessary for calculation of the luminance distribution value “var” is calculated using a luminance average value “avg[i]” of each sub-block “i” (where i=0, 1, 2, 3). That is, the luminance distribution value “var” and the luminance average value “avg” are determined using the following equations (4) and (5), respectively.

$$\begin{matrix}[ Equation 4 ] & \\ var = {\sum }_{j = 0}^{n - 1} {( {org\_blk}_{j} - avg )}^{2} / n & ( 4 ) \\ [ Equation 5 ] & \\ avg = {\sum }_{i = 0}^{3} avg [ i ] & ( 5 )\end{matrix}$$

Here, org_blk represents a pixel value of a luminance component of the input image, j represents pixel coordinates, and n represents the number of pixels in a block having an orthogonal transform size.

As described above, the second embodiment can also use the processing using the equation (1) in the first embodiment, while applying the quantization modulation.

### Third Embodiment

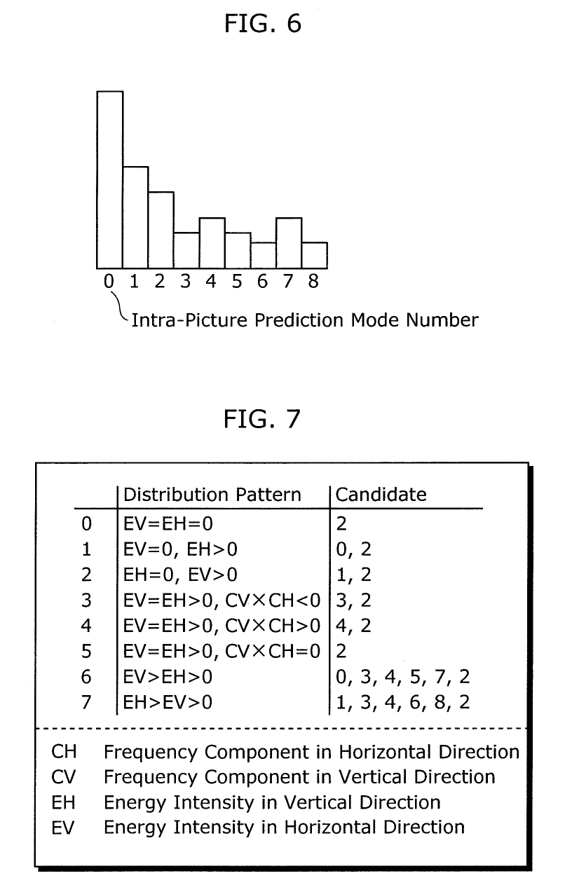

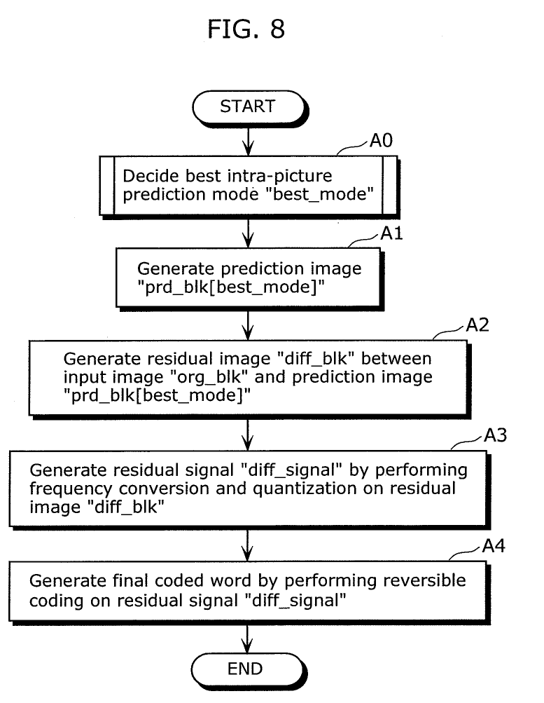

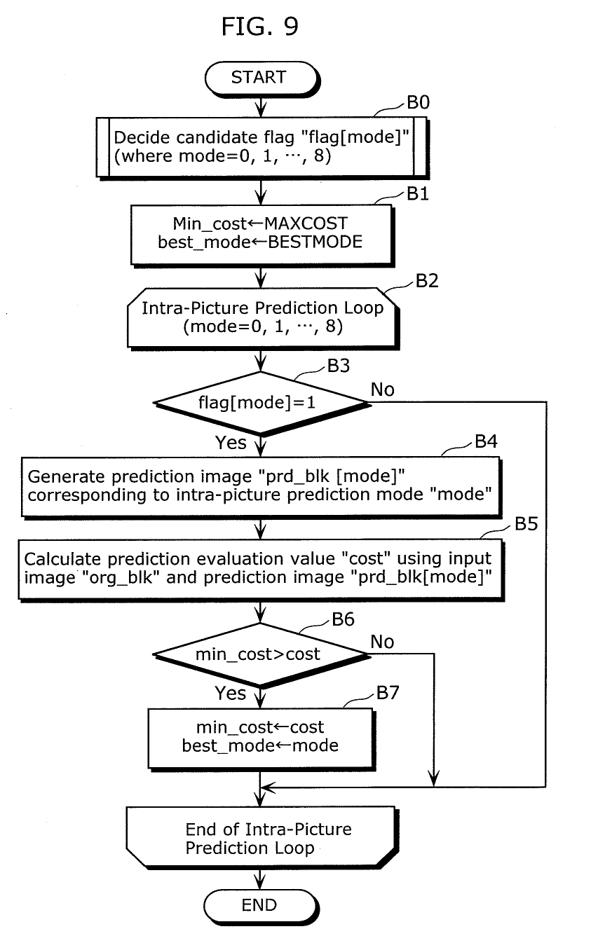

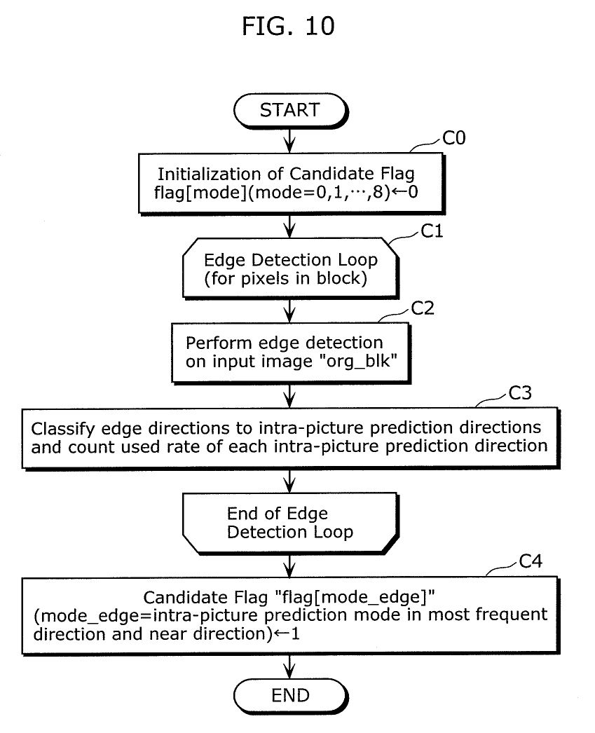

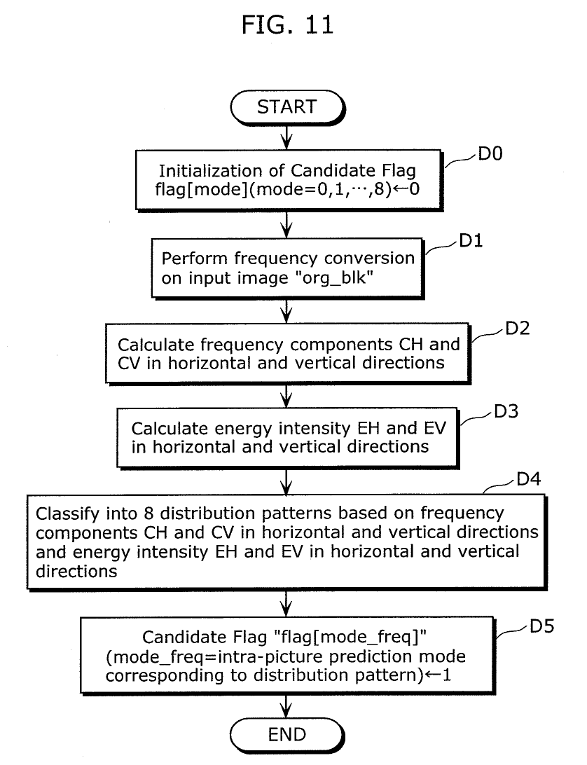

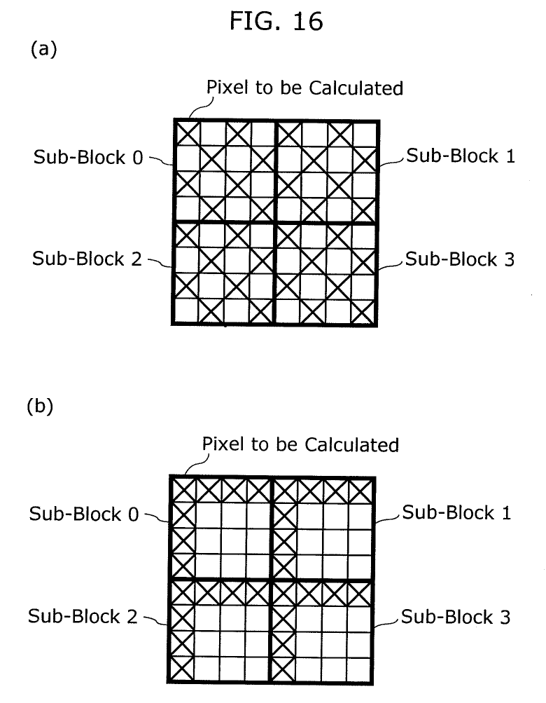

It has been described in the first embodiment that the luminance average value “avg[i]” of four sub-blocks “i” (where i=1, 2, 3) is calculated using all pixels in a sub-block “i”. However, in the third embodiment, the luminance average value “avg[i]” can be calculated using a part of the pixels by skipping pixels as shown in FIGS. 6 (a) and FIG. 16 (b), without using all of the pixels. Especially, as shown in FIG. 16 (b), it is possible to calculate a luminance average value “avg[i]” using pixels in a top row (four pixels in this case) and pixels in a far-left column (four pixels in this case) regarding each of the sub-blocks “i”. (In this case, an accuracy of selecting of prediction mode candidates is sometimes improved slightly more than the case of using all pixels.)

It should be noted that it has been described that the luminance average value “avg[i]” of each of the sub-blocks “i” (where i=0, 1, 2, 3) is calculated as a characteristic amount, but the characteristic amount is not limited to the luminance average value and may be a median value or a most frequent value of luminance of each sub-block “i”. It should also be noted that a shape of each sub-block (in other words, pixel arrangement) is not limited to a square, but may be a rectangular or the like including 4×8 pixels or 8×4 pixels.

It should also be noted that it has been described in the first embodiment that the luminance average values “avg[i]” are calculated from all of the four sub-blocks “i” (where i=0, 1, 2, 3), respectively, but at least three of the sub-blocks are required for the calculation in order to obtain absolute differential values “delta” regarding at least two directions. For example, as shown in FIG. 14 (a), it is possible to that an absolute differential value “delta_a” regarding a horizontal direction is calculated using the sub-block 0 and the sub-block 1, and an absolute differential value “delta_b” is calculated using the sub-block 1 and the sub-block 3. In this case, three sub-blocks are totally required.

It should also be noted that it has been described that the number of the sub-blocks positioned along the same single direction is two, but the number may be any of at least two, and may be three or more. In the case where three or more sub-blocks are positioned along the same single direction, a difference sum among (1) a representative value of a region (sub-block) the nearest to a starting point of the intra-picture prediction direction and (2) a value of each of the sub-bands along the same direction except the region (sub-block) the nearest to the starting point. In other words, if the difference sum is represented as “delta”, the “delta” is determined using the following equation (6).

$$\begin{matrix}[ Equation 6 ] & \\ delta = {\sum }_{i = 0}^{n - 1} \vert avg [ 0 ] - avg [ i ] \vert & ( 6 )\end{matrix}$$

Here, the “avg[i]” (where i=0, 1, . . . , n−1) is an luminance average value of the ith sub-block from the region (sub-block 0, for example) the nearest to a starting point of the intra-picture prediction direction, and n is the number of all sub-blocks positioned along the same intra-picture prediction direction.

### INDUSTRIAL APPLICABILITY

By the prediction mode deciding method, the image coding method, and the image coding device according to the present invention, it is possible to reduce a processing amount required for intra-picture prediction coding. Therefore, the prediction mode deciding method, the image coding method, and the image coding device according to the present invention are useful as methods and devices which performing image compression coding in mobile telephones, hard disk recorders, personal computers, and the like, for example.

1-10. (canceled)

11. A method of deciding an intra-picture prediction mode, said method being used by an image coding device which codes a residual between an input image and a generated intra-picture prediction image, and said method comprising:
calculating (i) a characteristic amount of each of at least three sub-blocks included in a block to be coded, the block being a part of the input image, and (ii-1) a difference in the characteristic amount between at least two of the sub-blocks along a prediction direction and (ii-2) a difference in the characteristic amount between at least two of the sub-blocks along another prediction direction different from the prediction direction;
selecting at least one intra-picture prediction mode candidate corresponding to one of the prediction direction and the another prediction direction where the difference in the characteristic amount is smaller of the calculated differences; and
deciding an intra-picture prediction mode from among the at least one intra-picture prediction mode candidate selected in said selecting.

12. The method of deciding an intra-picture prediction mode according to claim 11,
wherein the prediction direction is orthogonal to the another prediction direction, and
in said calculating of the differences, (ii-1) a difference in the characteristic amount between at least two of the sub-blocks along the prediction direction and (ii-2) a difference in the characteristic amount between at least two of the sub-blocks along the another prediction direction are calculated.

13. The method of deciding an intra-picture prediction mode according to claim 11,
wherein the block to be coded is divided into four rectangular sub-blocks which are positioned at an upper left corner of, at an upper right corner of, at an bottom left corner of, and at an bottom right corner of the block to be coded, and
in said calculating of the differences, (ii-1) a difference in the characteristic amount between the sub-block at the upper left corner and the sub-block at the bottom right corner and (ii-2) a difference in the characteristic amount between the sub-block at the upper right corner and the sub-block at the bottom left corner are calculated.

14. The method of deciding an intra-picture prediction mode according to claim 11,
wherein in said calculating of the characteristic amount, the characteristic amount is calculated using only pixels in a top row and pixels in a far-left column regarding each of the sub-blocks.

15. The method of deciding an intra-picture prediction mode according to claim 11,
wherein in said calculating of the difference in the characteristic amount, a difference between (1) the characteristic amount of a sub-block near a starting point of the prediction direction or the another prediction direction and (2) the characteristic amount of each of the at least two of the sub-blocks except the sub-block near the starting point.

16. The method of deciding an intra-picture prediction mode according to claim 11,
wherein the characteristic amount is one of an average value, a median value, and a most frequent value of luminance regarding all of pixels included in each of the sub-blocks, and
in said calculating, (i) one of the average value, the median value, and the most frequent value of the luminance regarding all of pixels included in each of the sub-blocks, and (ii-1) a difference in one of the average value, the median value, and the most frequent value of the luminance, between at least two of the sub-blocks along the prediction direction and (ii-2) a difference in one of the average value, the median value, and the most frequent value of the luminance, between at least two of the sub-blocks along the another prediction direction are calculated.

17. An image coding method of coding a residual between an input image and a generated intra-picture prediction image, said method comprising:
calculating (i) a characteristic amount of each of at least three sub-blocks included in a block to be coded, the block being a part of the input image, and (ii-1) a difference in the characteristic amount between at least two of the sub-blocks along a prediction direction and (ii-2) a difference in the characteristic amount between at least two of the sub-blocks along another prediction direction different from the prediction direction;
selecting at least one intra-picture prediction mode candidate corresponding to one of the prediction direction and the another prediction direction where the difference in the characteristic amount is smaller of the calculated differences;
deciding an intra-picture prediction mode from among the at least one intra-picture prediction mode candidate selected in said selecting; and
coding the residual between the input image and an intra-picture prediction image which is generated using the intra-picture prediction mode decided in said deciding.

18. An image coding device which codes a residual between an input image and a generated intra-picture prediction image, said device comprising:
a characteristic amount distribution unit operable to calculate (i) a characteristic amount of each of at least three sub-blocks included in a block to be coded, the block being a part of the input image, and (ii-1) a difference in the characteristic amount between at least two of the sub-blocks along a prediction direction and (ii-2) a difference in the characteristic amount between at least two of the sub-blocks along another prediction direction different from the prediction direction;
a prediction mode candidate selection unit operable to select at least one intra-picture prediction mode candidate corresponding to one of the prediction direction and the another prediction direction where the difference in the characteristic amount is smaller of the calculated differences;
a prediction mode decision unit operable to decide an intra-picture prediction mode from among the at least one intra-picture prediction mode candidate selected by said prediction mode candidate selection unit; and
a residual coding unit operable to code the residual between the input image and an intra-picture prediction image which is generated using the intra-picture prediction mode decided by said prediction mode decision unit.

19. A program used in an image coding device which codes a residual between an input image and a generated intra-picture prediction image, said program causing a computer to execute:
calculating (i) a characteristic amount of each of at least three sub-blocks included in a block to be coded, the block being a part of the input image, and (ii-1) a difference in the characteristic amount between at least two of the sub-blocks along a prediction direction and (ii-2) a difference in the characteristic amount between at least two of the sub-blocks along another prediction direction different from the prediction direction;
selecting at least one intra-picture prediction mode candidate corresponding to one of the prediction direction and the another prediction direction where the difference in the characteristic amount is smaller of the calculated differences; and
deciding an intra-picture prediction mode from among the at least one intra-picture prediction mode candidate selected in said selecting.

20. An integrated circuit which codes a residual between an input image and a generated intra-picture prediction image, said integrated circuit comprising:
a characteristic amount distribution unit operable to calculate (i) a characteristic amount of each of at least three sub-blocks included in a block to be coded, the block being a part of the input image, and (ii-1) a difference in the characteristic amount between at least two of the sub-blocks along a prediction direction and (ii-2) a difference in the characteristic amount between at least two of the sub-blocks along another prediction direction different from the prediction direction;
a prediction mode candidate selection unit operable to select at least one intra-picture prediction mode candidate corresponding to one of the prediction direction and the another prediction direction where the difference in the characteristic amount is smaller of the calculated differences;
a prediction mode decision unit operable to decide an intra-picture prediction mode from among the at least one intra-picture prediction mode candidate selected by said prediction mode candidate selection unit; and
a residual coding unit operable to code the residual between the input image and an intra-picture prediction image which is generated using the intra-picture prediction mode decided by said prediction mode decision unit.
